(19) United States
(12) Patent Application Publication
(10) Pub. No.: US 2017/0224569 A1
(43) Pub. Date: Aug. 10, 2017

(54) GRIPPING CLAW FOR MOUNTING ON A SLIDE RAIL OF AN OPERATING TABLE

(71) Applicant: MAQUET GMBH, RASTATT (DE)

(72) Inventors: Reinhard PFEUFFER, Elchesheim-Illingen (DE); Bernhard KATZENSTEIN, Iffezheim (DE)

(73) Assignee: MAQUET GMBH, RASTATT (DE)

(21) Appl. No.: 15/581,356

(22) Filed: Apr. 28, 2017

Related U.S. Application Data
(63) Continuation-in-part of application No. PCT/EP2015/073899, filed on Oct. 15, 2015.

(30) Foreign Application Priority Data
Nov. 6, 2014 (DE) 10 2014 116 169.6

(51) Int. Cl. A61G 13/10; F16B 2/18; F16M 13/02; F16B 2/10

(52) U.S. Cl. CPC A61G 13/101; F16B 2/10; F16B 2/185; F16M 13/02

(57) ABSTRACT

A clamping apparatus is disclosed. The clamping apparatus has a main body having at least one bearing surface designed to bear against the structural member of the operating table. The clamping apparatus also has a clamp assembly that is attached to the main body and has a first bearing member and a second bearing member. The clamping apparatus further has an actuating assembly that is operatively connected to the clamp assembly and that actuates the clamp assembly into a locked state in which the at least one bearing surface of the main body and the first and second bearing members of the clamp assembly bear against the structural member.

### CROSS REFERENCE TO RELATED APPLICATIONS

The present application is a continuation-in-part filed under 35 U.S.C. §111(a), and claims the benefit under 35 U.S.C. §§365(c) and 371 of PCT International Application No. PCT/EP2015/073899, filed Oct. 15, 2015, and which designates the United States of America, and German Patent Application No. 10 2014 116 169.6, filed Nov. 6, 2014. The disclosures of these applications are herein incorporated by reference in their entirety.

### TECHNICAL FIELD

The disclosure relates to a clamping claw for attachment to a slide rail of an operating table, comprising for example a main body having at least one bearing surface which may be designed to bear against the slide rail, a clamp structure which may be attached to the main body and which may have a first bearing element and a second bearing element, and an actuating member which may be operatively connected to the clamp structure, and the actuation of which may allow the clamp structure to be brought into a locked state in which the bearing surface of the main body and the bearing elements of the clamp structure bear against the slide rail.

### BACKGROUND

Operating tables typically have what are known as slide rails along both sides of their table segments. These slide rails are generally rectangular in cross-section and are used for the attachment of accessory parts, such as patient support aids, to the operating table in the desired position. To secure the accessory parts, clamping claws are typically used, which are coupled to the accessory part in question and are attached to the slide rail.

Often, these clamping claws are used on different model types of operating tables, which differ from one another in terms of the dimensions of their slide rails, among other things. Users therefore use a clamping claw that can be used flexibly on operating tables with different slide rails. The orientation of the clamping claw relative to the slide rail should remain largely the same regardless of the specific rail dimensions, so that any desired repositioning of the accessory that is secured to the clamping claw can be accomplished relatively easily. Furthermore, since the orientation remains the same, the clamping claw remains properly attached.

Such a clamping claw, also known as a clamping block, is typically composed of a bracket-shaped part, which may be slid onto the slide rail and then fixed in the desired position by a clamping screw. Some designs allow clamping claws to be pivoted onto the slide rail at any point along the rail and thereby secured to the slide rail relatively quickly, without involving access from an end of the slide rail. Pivoting the clamping claw during its attachment to the slide rail is typically done, which involves the accessory attached to the clamping claw to also be pivoted. This has the disadvantage that the accessory, for example a lateral support that is attached to the clamping claw, is pivoted along with the clamping claw during attachment to the slide rail, and a patient who is already lying on the operating table is first be moved into a different position.

Some known clamping claws grip in the manner of a hook over the upper end of a slide rail have a rectangular cross-section. Tapered interior flanks of the clamping claw thereby come to bear against the two upper longitudinal edges of the slide rail, which run parallel to one another. A clamping element, which is guided upward by means of a tommy screw, for example, in turn comes to bear with an inclined surface against the lower inner edge of the slide rail, fixing the clamping claw in place once it has been tightened. Force is thus transmitted from the clamping claw to the slide rail nearly exclusively via the edges of the slide rail. Depending on the degree of rounding of the edges, different and relatively high surface pressures typically result, which significantly limit the load bearing capacity of the clamping claw. The connection between the clamping claw and the slide rail is typically pliable and yielding, because the high load concentration can result in localized deformations of the edges. Furthermore, the tolerances for clearance and for edge rounding are typically combined in the diagonal direction of the rectangular cross-section. Conventional clamping claws typically do not compensate for these tolerances.

### SUMMARY OF THE DISCLOSURE

In at least some exemplary embodiments, a clamping claw can be attached relatively easily and suitably (e.g., securely) in a predefined orientation to rectangular slide rails of different dimensions.

In at least some exemplary embodiments, a first bearing element may be mounted pivotably about a first pivot axis, which may be parallel to the longitudinal axis of the slide rail and may be stationary relative to the main body. The second bearing element may be mounted pivotably about a second pivot axis, which may be parallel to the first pivot axis and which may be movable relative to the main body.

In at least some exemplary embodiments, the actuating member may be operatively connected to the second bearing element. When the actuating member is actuated in order to move the second bearing element into a position bearing against the slide rail, the second bearing element can be pivoted about the second pivot axis to the desired alignment. At the same time, the first bearing element may be pivoted about the first pivot axis and thus brought into a position bearing against the slide rail.

In at least some exemplary embodiments, the two bearing elements and the two pivot axes (e.g., the first pivot axis for example being arranged in a stationary manner relative to the main body of the clamping claw and the second pivot axis being movably arranged) may form a clamp structure which may automatically align itself with the rail surfaces during its attachment to the slide rail. Dimensional tolerances for the height of the slide rail and the formation of the edges may thus no longer influence the alignment of the clamping claw, which may be attached together with the accessory part to the slide rail. A fixed alignment of the clamping claw relative to the slide rail may be provided based on the bearing surface of the main body being positioned against the slide rail (e.g., establishing the alignment of the clamping claw). The two bearing elements may then be positioned on the slide rail and may be tightened against the rail surfaces by actuating the actuating member. In this process, the movement of the second bearing element may be coupled to the pivoting movement so as to provide the desired (e.g., automatic) alignment on the slide rail.

In at least some exemplary embodiments, a pivoting movement of the first bearing element about the first pivot axis may be a movement designed to compensate for dimensional tolerances. The pivot angle by which the first bearing element is pivoted for tolerance compensation may therefore be relatively small, e.g. within a range of a few degrees.

In at least some exemplary embodiments, a clamp structure may have an eccentric shaft, which may be coupled to the actuating member and can be pivoted together with the first bearing element about the first pivot axis, and which may comprise at least one shaft section and one cam. The eccentric shaft may have at least one shaft section that is rotatable about a rotational axis of the eccentric shaft, and a cam that is embodied as eccentric with respect to the rotational axis of the eccentric shaft. The second pivot axis may be stationary relative to the cam, and the second bearing element may be mounted pivotably on the cam. The second bearing element may be coupled to the first bearing element by the aforementioned eccentric shaft, so that the two bearing elements simultaneously execute a pivoting movement with the actuation of the actuating member. This pivoting movement of the second bearing element may be a combined movement that results from a pivoting of the cam and a pivoting of the second bearing element about the cam. The pivoting of the cam and the resulting (pivoting) movement of the second bearing element mounted on the cam may be effected directly by the actuation of the actuating member. The additional pivoting of the second bearing element about the second pivot axis may result from the contact of the moved second bearing element with the slide rail. The second pivot axis may be a longitudinal axis of the cam. The first bearing element may be pivoted about the first pivot axis, which may be stationary relative to the main body. This pivoting movement may also be transmitted to the second bearing element by the coupling, via the eccentric shaft, to the first bearing element.

The provision of two pivotable bearing elements may allow the clamping claw to be attached to rectangular slide rails of different dimensions, and may keep the design of the clamping claw relatively simple and compact. To attach the clamping claw to the slide rail, the bearing surface of the main body may first be positioned on the slide rail, establishing the orientation of the clamping claw on the slide rail. Once the bearing surface of the main body has been positioned on the slide rail, the bearing elements may be positioned on the slide rail, fixing the clamping claw to the same. The second bearing element may be operatively connected via the eccentric shaft to the first bearing element, so that the two bearing elements can simultaneously execute a pivoting movement. For example, when the actuating member is actuated, the second bearing element may be moved by a pivoting of the cam about the rotational axis of the eccentric shaft and may be pivoted about the second pivot axis by the contact of the second bearing element with the slide rail.

In at least some exemplary embodiments, when the clamp structure is in the locked state, the bearing surface of the main body may bear against a first side of the slide rail. In addition, when the clamp structure is in the locked state, a bearing surface of the first bearing element may bear against a second side of the slide rail, and a bearing surface of the second bearing element bears against a third side of the slide rail. Furthermore, when the clamp structure is in the locked state, a further bearing surface of the main body may bear against a fourth side of the slide rail. The slide rail may thus be surrounded on four sides by the clamping claw, and the clamping claw may be securely attached to the slide rail. Moreover, the clamping claw may bear stably against the slide rail as soon as the main body has been positioned on the slide rail. For example, the first side may be the upper side, the second side may be the outer side facing away from the operating table, the third side may be the underside of the slide rail, and the fourth side may be the inner side of the slide rail facing the operating table.

In at least some exemplary embodiments, a further bearing surface of the second bearing element may bear against the fourth side of the slide rail when the clamp structure is in the locked state. In this way, detachment of the clamping claw when relatively strong external forces are exerted on the clamping claw may be substantially prevented, thereby providing a suitable grip of the clamping claw on the slide rail.

In at least some exemplary embodiments, the at least one shaft section of the eccentric shaft may be mounted on the first bearing element so as to rotate about the rotational axis of the eccentric shaft. The eccentric shaft can also be rotated about its axis of rotation by the actuation of the actuating member to lock the clamp structure, and when the eccentric shaft is rotated, the cam can be pivoted about its axis of rotation. A coupling of the eccentric shaft to the second bearing element and thus an operative connection of the second bearing element to the first bearing element may thereby be achieved in a particularly simple manner. When the cam is pivoted, the second bearing element may be moved together with the cam, and thereby positioned against the slide rail. Furthermore, when the second bearing element is pivoted, the bearing surface of the second bearing element, which may contact the slide rail, may maintain its orientation relative to the slide rail due to the alignment of the pivot axis parallel to the longitudinal axis of the slide rail. As a result, the second bearing element may contact the slide rail with its intended bearing surface, providing a secure bearing.

In at least some exemplary embodiments, the second bearing element may have a through hole through which the cam is guided. In addition, the at least one shaft section may have a first shaft section and a second shaft section. The cam may be arranged between the first shaft section and the second shaft section. A stable mounting of the eccentric shaft on the first bearing element and on the second bearing element may thereby be provided in a relatively simple manner.

In at least some exemplary embodiments, the first shaft section, the second shaft section and the cam may be cylindrical. The first shaft section and the second shaft section may have a common longitudinal axis that forms the rotational axis of the eccentric shaft. The cam may be arranged relative to the shaft sections in such a way that the longitudinal axis of the cam may be disposed at a distance from and parallel to the longitudinal axis of the shaft sections. Due to the parallel displacement of the longitudinal axis of the cam relative to the longitudinal axis of the shaft sections, the longitudinal axis of the cam and thus the second bearing element can be pivoted easily about the longitudinal axis of the shaft sections. The second bearing element can also be pivoted easily about the longitudinal axis of the cam as a result of said displacement.

In at least some exemplary embodiments, the first bearing element may have a first arm and a second arm. The second bearing element may be arranged between the first arm and the second arm of the first bearing element. In addition, the first arm may have a first opening and the second arm may have a second opening; the first shaft section may be guided through the first opening and the second shaft section may be guided through the second opening. This may provide a clamping claw that is relatively compact and stable. In addition, it may substantially prevent the uneven exertion of forces along the longitudinal axis of the slide rail.

In at least some exemplary embodiments, the first arm and the second arm may each have a circular opening, through each of which a bolt formed on the main body may be guided. The first bearing element may be mounted rotatably on the bolt that defines the first pivot axis. The distance of each of the bolts from the slide rail may be greater than the distance of the cam that defines the second pivot axis from the slide rail. When the second bearing element is pivoted up to the third (lower) side of the slide rail, it may exert a force on the eccentric shaft and thus on the first bearing element. The first bearing element may thereby be pressed against the second (outer) side of the slide rail. The greater the difference between the distance of the first pivot axis defined by the bolts from the slide rail and the second pivot axis defined by the eccentric from the slide rail, the more strongly the first bearing element may be pressed against the slide rail by the force which is transmitted to the eccentric shaft when the second bearing element moves toward the slide rail. The grip of the clamping claw on the slide rail in the locked state may thus be improved.

In at least some exemplary embodiments, the above-described difference in the distances of the two pivot axes from the slide rail, regardless of the specific implementation of the two pivot axes, may provide a suitable configuration of the clamping claw.

In at least some exemplary embodiments, a pin may be connected to the cam and may project into a recess in the second bearing element. The pin can be brought into engagement with the second bearing element when the eccentric shaft is rotated about its rotational axis. When the pin is engaged, the second bearing element can be pivoted about the second pivot axis upon rotation of the eccentric shaft. Such a pivoting movement can be used to move the second bearing element so as to release the clamping claw from the slide rail. In addition, the actuation of the eccentric shaft by the actuating element may make the provision of a further actuating element unsuitable, thereby improving user-friendliness.

In at least some exemplary embodiments, the second bearing element may be a substantially L-shaped element having a first arm and a second arm, which may be longer than the first arm. The bearing surface of the second bearing element may be formed on the first arm, and the through hole of the second bearing element may be formed in the longer second arm. As a result, a relatively small (e.g., minimal) movement of the second bearing element may occur in order to position the second bearing element on the slide rail or to move it into the open position.

In at least some exemplary embodiments, the clamp structure may have a prestressing element which can be used for prestressing the second bearing element into a receiving position before the main body is positioned on the slide rail. In addition, when the main body is bearing against the slide rail, the bearing surface of the second bearing element may be pressed by the prestressing element against the slide rail, for example on the third (e.g., lower) side thereof. Thus the second bearing element may be automatically placed in the receiving position, in which the clamping claw can be easily positioned on the slide rail, before it is positioned on the slide rail. During positioning, the clamping claw may then be moved linearly toward the slide rail until the second bearing element contacts the slide rail. When the clamping claw is pressed against the slide rail, the second bearing element may be pivoted in the second pivoting direction, counter to the prestressing force that is exerted by the prestressing element, until the slide rail is encompassed by the clamping claw. This can be accomplished without tilting the clamping claw relative to the slide rail.

In at least some exemplary embodiments, the main body may have an edge recess located between the bearing surface and the further bearing surface; said edge recess may accommodate the first rail edge, which may be located between the first (upper) side of the slide rail and the fourth (inner) side of the slide rail, without contact. The slide rail may therefore be contacted on all four sides and is thereby suitably (e.g., securely) encompassed by the clamping claw. Moreover, since the main body contacts the slide rail on the flat sides thereof rather than on a rail edge, different fillets along the rail edge may have no adverse effect on the grip of the clamping claw on the slide rail.

In at least some exemplary embodiments, the second bearing element may engage in an edge region of the slide rail in which the second rail edge, positioned between the third (lower) side of the slide rail and the fourth (inner) side of the slide rail, is located. The second bearing element may have an edge recess that receives the second rail edge without contact. In this way, the second bearing element may contact the slide rail on the flat sides thereof.

In at least some exemplary embodiments, the actuating member may be an actuating lever that is (e.g., fixedly) connected to the eccentric shaft and can be pivoted with the eccentric shaft about its rotational axis. In that case, when the clamp structure is in the locked state, the actuating lever can be locked in place by a pawl and ratchet mechanism. The design of the actuating member as a lever may allow relatively strong (e.g., high) forces to be transmitted to the bearing elements, providing a relatively secure grip of the clamping claw on the slide rail. Relatively strong gripping forces can be achieved in the locked state by locking the actuating lever in place by the pawl and ratchet mechanism. The pawl and ratchet mechanism may be designed such that when the actuating lever is locked in place, it is fixed only counter to the direction of actuation. This may substantially prevent the locked clamping claw from becoming detached from the slide rail. At the same time, users may still be able to tighten the clamp structure firmly (e.g., even more firmly) against the slide rail by pressing the actuating lever further in the actuation direction. Alternatively, the actuating lever may be locked in place directly on the eccentric shaft.

In at least some exemplary embodiments, the pawl and ratchet mechanism may comprise a ratchet element that is connected to the first bearing element or that is embodied as integral therewith, and at least one pawl that may be connected to the actuating lever. In this case, the pawl can be brought into interlocking engagement with the ratchet element and can be released from the interlocking engagement, and when the pawl is engaged in the ratchet element, it may lock the actuating lever in place. By coupling the pawl and ratchet mechanism to the first bearing element, both the ratchet element and the actuating lever may be pivoted along with the first bearing element, and thereby may maintain their positions relative to one another even during pivoting movements of the bearing elements.

In at least some exemplary embodiments, a first pawl and a second pawl may be provided, and the actuating lever may have an actuating element, wherein the first pawl and the second pawl can be released from the interlocking engagement by actuating the actuating element. This may serve to provide for the actuating lever being securely locked in place, thereby fastening the clamping claw (e.g., securely) to the slide rail. For example, the pawls and the ratchet element of this release mechanism may be designed such that the pawls are securely supported on the teeth of the interlocking engagement, e.g. a heavy-duty tooth geometry may be provided.

### BRIEF DESCRIPTION OF THE DRAWINGS

Additional features and advantages of the disclosure will be apparent from the following description, which explains the disclosure in the context of exemplary embodiments, with reference to the accompanying figures.

FIG. 1 illustrates a perspective view of an exemplary clamping claw according to a first exemplary embodiment, attached to a slide rail.

FIG. 2 illustrates a sectional side view of the clamping claw attached to the slide rail.

FIG. 3 illustrates a perspective view of a main body of the clamping claw.

FIG. 4 illustrates a perspective view of elements of a clamp structure of the clamping claw bearing against the slide rail.

FIG. 5 illustrates a perspective view of an eccentric shaft and an actuating element of the clamp structure of FIG. 4.

FIG. 6 illustrates a perspective view of the eccentric shaft, the actuating element and a swivel lock of the clamp structure of FIG. 4.

FIG. 7 illustrates a sectional side view of the clamping claw shown from a perspective opposite that of FIG. 2, in which additional functional elements are visible.

FIG. 8 illustrates a perspective view of the clamping claw, in which elements of a pawl and latch mechanism for locking the clamping claw are visible.

FIG. 9 illustrates a view from the top of parts of the clamping claw, showing the elements of the pawl and latch mechanism with the clamp structure in an unlocked state.

FIG. 10 illustrates a side view of the clamping claw before positioning on the slide rail, with a swivel lock of the clamp structure in a receiving position.

FIG. 11 illustrates a side view of the clamping claw after being brought up to the slide rail, with the swivel lock in an open position.

FIG. 12 illustrates a side view of the clamping claw positioned on the slide rail with the swivel lock in the receiving position.

FIG. 13 illustrates a sectional side view of the main body of the clamping claw bearing against the slide rail.

FIG. 14 illustrates a side view of the clamping claw positioned on the slide rail, with the swivel lock in an intermediate position between the receiving position and a closed position.

FIG. 15 illustrates a side view of the clamping claw positioned on the slide rail, in a fixed state.

FIG. 16 illustrates a side view of the clamping claw positioned on the slide rail with the clamp structure in a locked state.

FIG. 17 illustrates a sectional side view of the clamping claw positioned on the slide rail with the clamp structure in the locked state.

FIG. 18 illustrates a sectional side view of the clamping claw with the swivel lock in an intermediate position between the receiving position and the closed position.

FIG. 19 illustrates a sectional side view of the clamping claw with the swivel lock in a further intermediate position between the receiving position and the closed position.

FIG. 20 illustrates a sectional side view of the clamping claw with the swivel lock in an intermediate position between the receiving position and the open position.

FIG. 21 illustrates a sectional side view of the clamping claw with the swivel lock in an open position.

FIG. 22 illustrates a sectional side view of the clamping claw bearing on the slide rail, in which the forces acting on the slide rail are indicated.

FIG. 23 illustrates a perspective view of a clamping claw according to a second exemplary embodiment.

FIG. 24 illustrates a perspective view of the clamping claw according to the second embodiment, from a different perspective.

FIG. 25 illustrates a perspective view of a main body of the clamping claw according to the second embodiment.

FIG. 26 illustrates a perspective view showing elements of a clamp structure of the clamping claw according to the second embodiment.

FIG. 27 illustrates a perspective view of a further selection of elements of the clamp structure of the clamping claw according to the second embodiment.

FIG. 28 illustrates a sectional side view of the clamping claw according to the second embodiment with a swivel lock of the clamping claw in the receiving position.

FIG. 29 illustrates a sectional side view of the clamping claw according to the second embodiment with the swivel lock in an intermediate position between the receiving position and the closed position.

FIG. 30 illustrates a sectional side view of the clamping claw according to the second embodiment with the swivel lock in the closed position.

FIG. 31 illustrates a sectional side view of the clamping claw according to the second embodiment with the swivel lock in the open position.

### DETAILED DESCRIPTION AND INDUSTRIAL APPLICABILITY

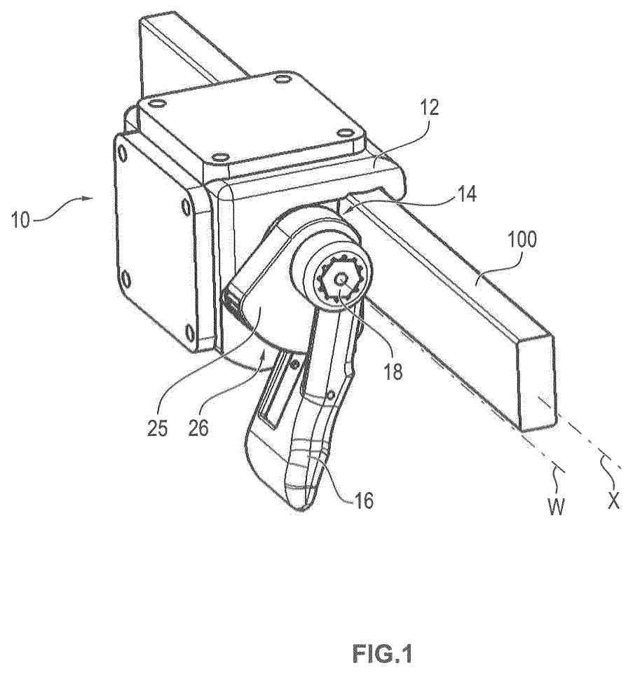

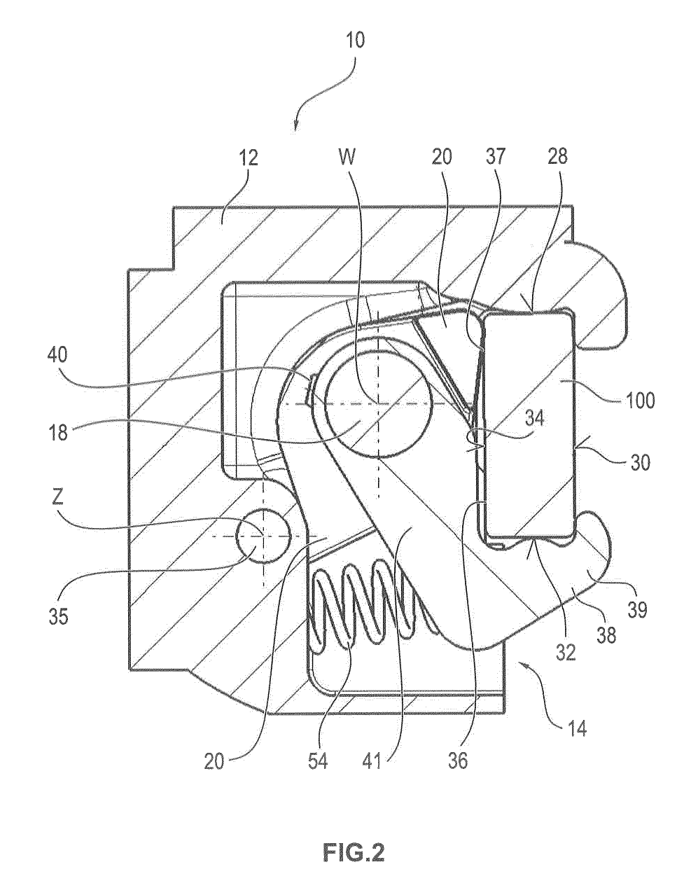

FIG. 1 shows a perspective view and FIG. 2 shows a sectional side view of a clamping apparatus (e.g., clamping claw 10), attached to a structural member 100 of an operating table (e.g., slide rail 100). Slide rail 100 may have a rectangular cross-section and may be encompassed by clamping claw 10 transversely to the longitudinal axis X of slide rail 100. Slide rail 100 may be contacted by clamping claw 10 on its upper rail surface 28, on an inner rail surface 30 that faces an operating table, on its lower rail surface 32 and on its outer rail surface 34, and may be clamped in such a way that clamping claw 10 may be securely attached to slide rail 100.

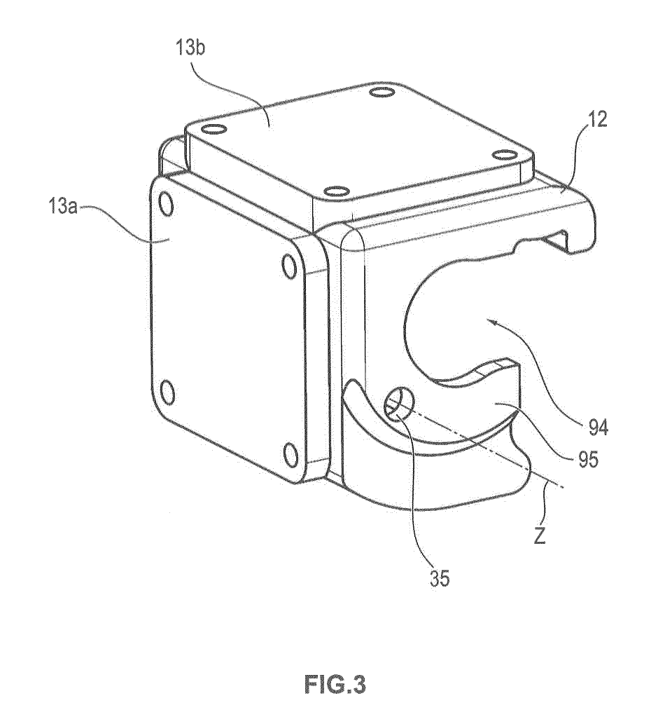

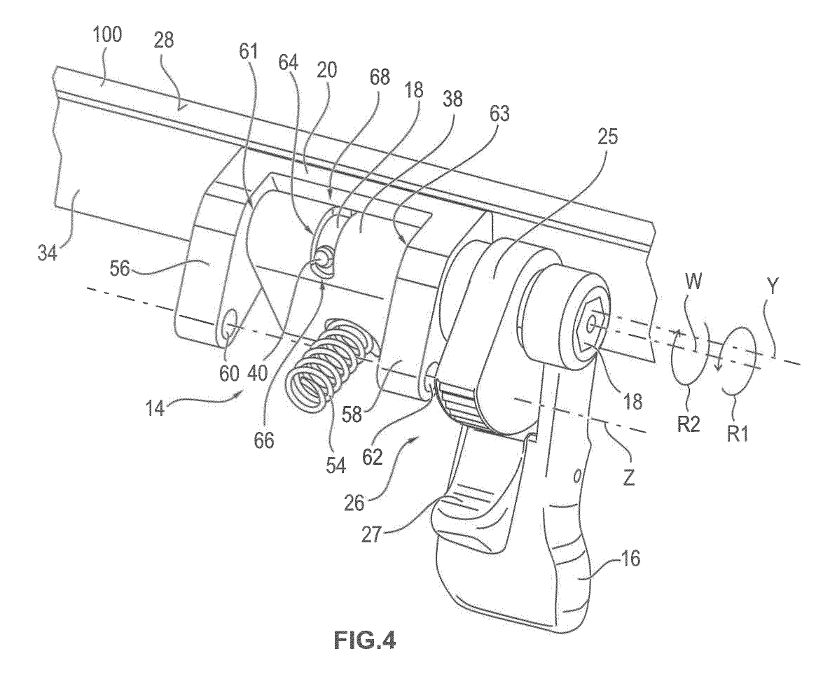

Clamping claw 10 may comprise a main body 12, shown separately in FIG. 3, with coupling interfaces 13a and 13b for the attachment of operating table accessories, and a clamp assembly (e.g., clamp structure) denoted generally as 14, a perspective view of which is shown in FIG. 4 bearing against slide rail 100 with main body 12 removed. Clamp structure 14 may comprise a first bearing member (e.g., support element 20), which may form a first bearing element for bearing against slide rail 100, a second bearing member (e.g., swivel lock 38), which may form a second bearing element for bearing against slide rail 100, an eccentric shaft 18, an actuating assembly (e.g., actuating lever 16), a pawl and ratchet mechanism 26 and a prestressing member (e.g., a helical compression spring 54).

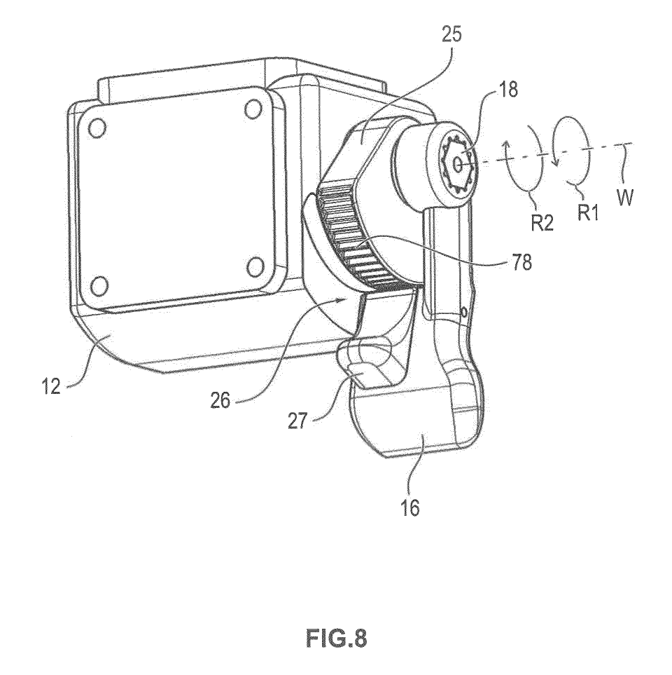

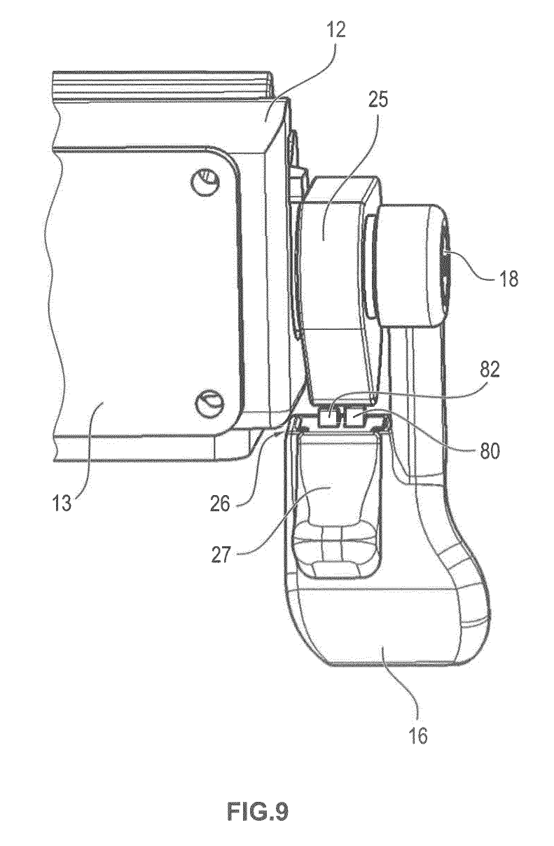

Support element 20 may have a first arm 56, shown in FIG. 4, with a first circular opening 60 and a second arm 58 with a second circular opening 62, through each of which a bolt which is connected to the main body 12 may be guided. The bolts may each project into a through hole 35 in main body 12 and may have a common longitudinal axis Z, about which support element 20 may be mounted pivotably on the bolt. In addition, the first arm 56 of support element 20 may have a third circular opening 61, and the second arm 58 of the support element may have a fourth circular opening 63. The fourth circular opening may be designed as a through hole through the second arm 58 and through a ratchet element 25 of the pawl and ratchet mechanism 26, which ratchet element may be connected to the second arm 58. The design of the pawl and ratchet mechanism 26 will be explained in greater detail in reference to FIGS. 8 and 9.

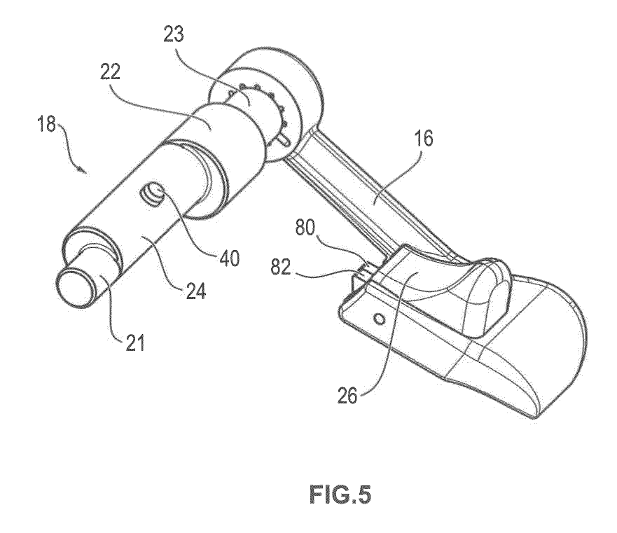

Eccentric shaft 18, which is shown in FIG. 5 together with actuating lever 16, may be mounted rotatably in openings 61 and 63 of support element 20. Eccentric shaft 18 may have a first shaft section 21, a second shaft section 22, a third shaft section 23 and a cam 24. Shaft sections 21, 22 and 23 may be designed as cylindrical and may have a common longitudinal axis W. The cylindrical cam 24 may be arranged between first shaft section 21 and second shaft section 22 and may be fixedly connected thereto in such a way that the longitudinal axis Y of cam 24 is offset from and parallel to the longitudinal axis W of shaft sections 21, 22 and 23. Third shaft section 23 may be fixedly connected at one end to second shaft section 22 and at the other end to actuating lever 16.

In addition, first shaft section 21 may be guided through third opening 61, and second shaft section 22 together with fourth shaft section 23 may be guided through fourth opening 63, with each said shaft section being mounted on support element 20 so as to rotate about longitudinal axis W. Due to the mounting of shaft sections 21, 22 and 23 so as to rotate about longitudinal axis W, these sections may form a rotational axis of eccentric shaft 18, about which eccentric shaft 18 can rotate in a first direction of rotation R1 and in an opposite, second direction of rotation R2, as indicated in FIG. 4.

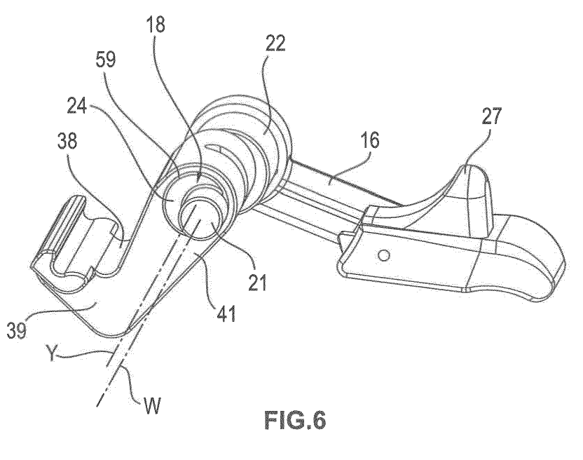

Cam 24 may be further guided through a through hole 59 in swivel lock 38, which may be located between arms 56 and 58 of support element 20; said through hole may be circular in cross-section and is shown in FIG. 6. Swivel lock 38 may thereby be mounted on cam 24 so as to rotate about the longitudinal axis Y thereof.

Swivel lock 38 may be designed as substantially L-shaped and may have a first arm 39 and a second arm 41, which may be longer than the first. In FIG. 2, the first arm 39 may engage around slide rail 100 from below. Eccentric shaft 18 may be guided through the upper end of the second arm 41.

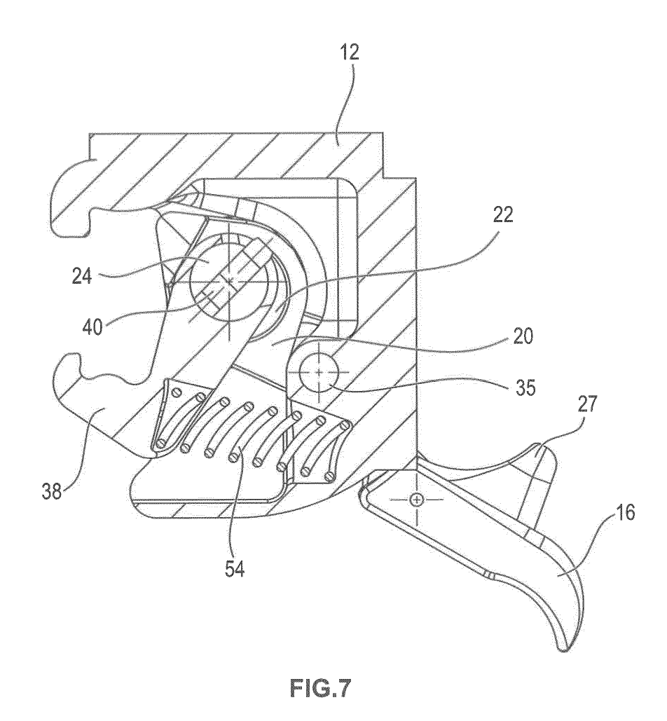

Eccentric shaft 18 may further have a pin 40, shown in FIG. 4, which may be guided through an elongated opening 64 in swivel lock 38. Swivel lock 38 may have a first stop 66, formed by the lower end of elongated opening 64 in FIG. 4, and a second stop 68, formed by the upper end of elongated opening 64 in FIG. 3, which can be used respectively for stopping pin 40 by a rotation of eccentric shaft 18 about its longitudinal axis Y in a first direction of rotation R1 or in a second direction of rotation R2, opposite the first. In FIG. 7, in a cross-section of clamping claw 10 that extends through pin 40, pin 40 is shown in a middle position between first stop 66 and second stop 68.

In addition, swivel lock 38 may have a recess in which helical compression spring 54 contacts swivel lock 38, and main body 12 may have a recess in which the helical compression spring contacts main body 12. Helical compression spring 54 may thus exert a spring force on the lower end of swivel lock 38 in FIGS. 2 and 7, thereby prestressing the swivel lock toward slide rail 100. This places swivel lock 38 in a prestressed swivel position relative to support element 20.

On the side of support element 20 that faces away from swivel lock 38, eccentric shaft 18 may pass out of ratchet element 25 and may be fixedly connected at its end to an actuating lever 16. Actuating lever 16 may thus be capable of rotating together with eccentric shaft 18 about its rotational axis W. An actuating element 27 of pawl and ratchet mechanism 26 may also be attached to actuating lever 16.

FIG. 8 shows a perspective view of clamping claw 10, in which elements of pawl and ratchet mechanism 26 for locking clamping claw 10 are visible. FIG. 9 is a view from the top of parts of clamping claw 10, showing the elements of pawl and ratchet mechanism 26 when clamp structure 14 is in an unlocked state. As has already been mentioned, pawl and ratchet mechanism 26 may comprise ratchet element 25 and actuating element 27, along with a first pawl 80 and a second pawl 82, which are also shown in FIG. 5. Also formed on ratchet element 25 may be, for example, saw teeth 78.

In the position of actuating lever 16 shown in FIG. 8, first pawl 80 and second pawl 82 may be engaged in the saw teeth 78 of ratchet element 25, locking actuating lever 16 in place and preventing it from rotating in the second direction of rotation R2. First pawl 80 and second pawl 82 can be disengaged from saw teeth 78 by pressing on actuating element 27, thereby releasing actuating lever 16. For example, in so doing, actuating element 27 acts on a mechanism contained in the actuating lever 16, with which pawls 80 and 82 are drawn into actuating lever 16. While actuating element 27 is pressed down, actuating lever 16 can be rotated about rotational axis W of eccentric shaft 18 in the second direction of rotation R2. FIG. 9 shows the position of actuating lever 16 following a rotation into the unlocked state of clamp structure 14.

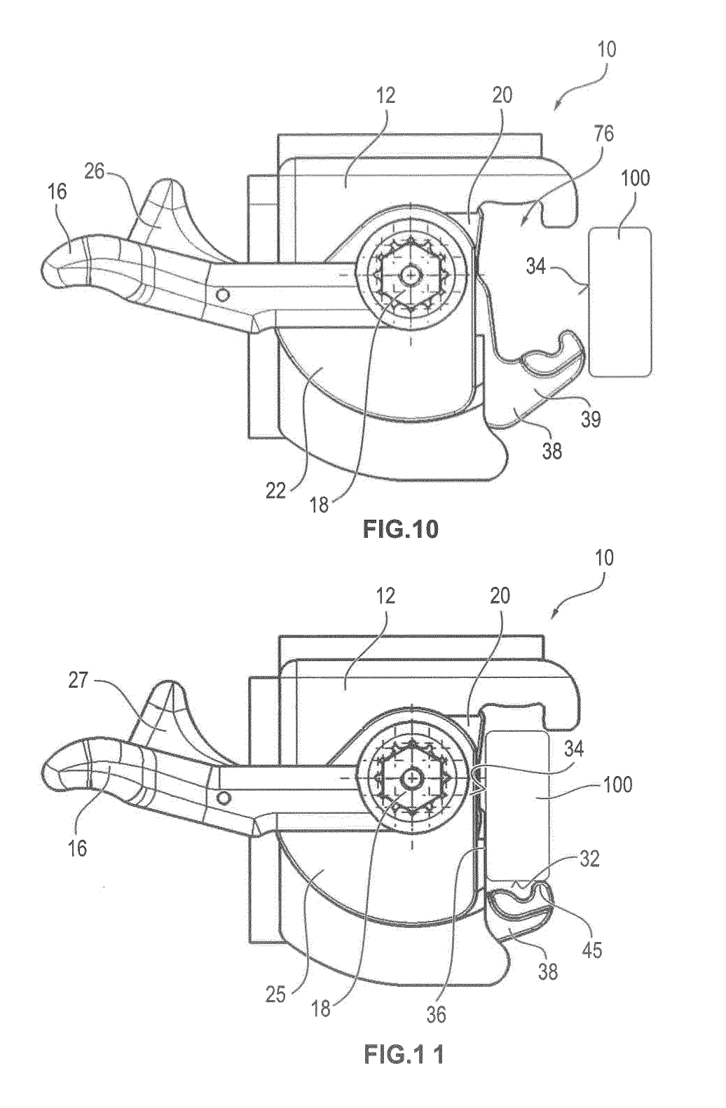

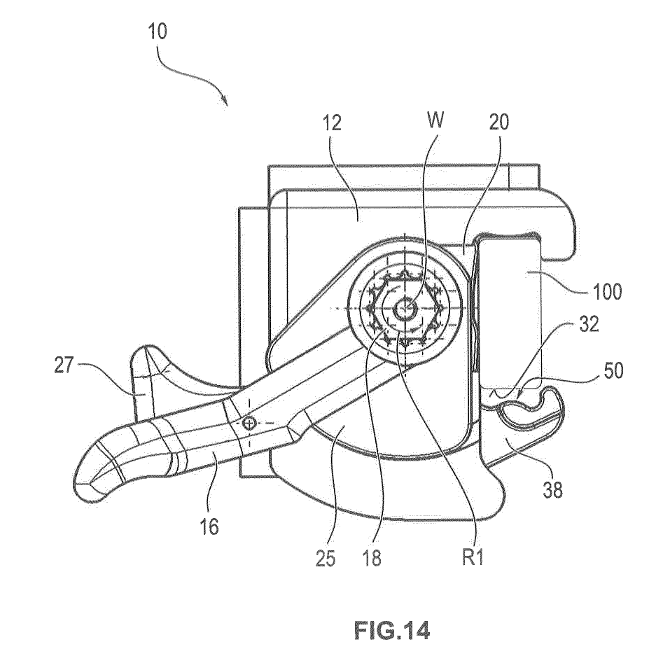

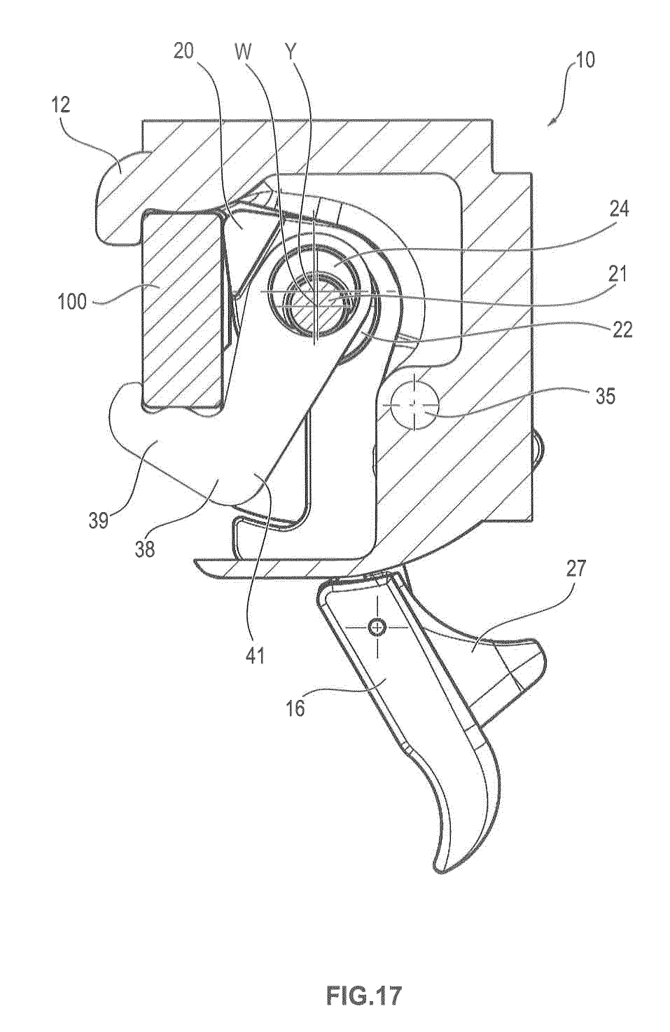

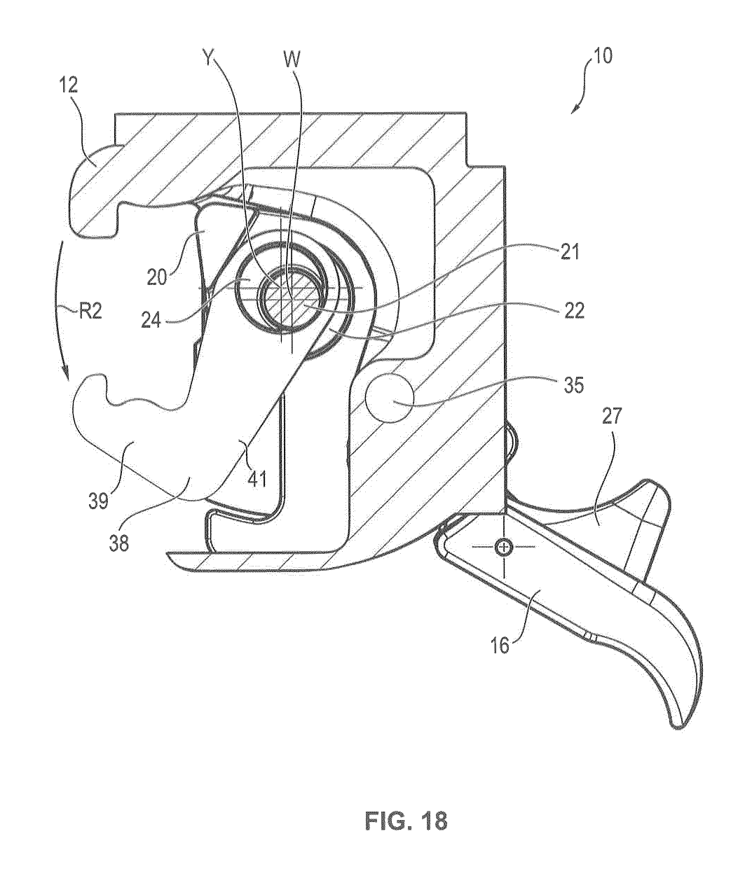

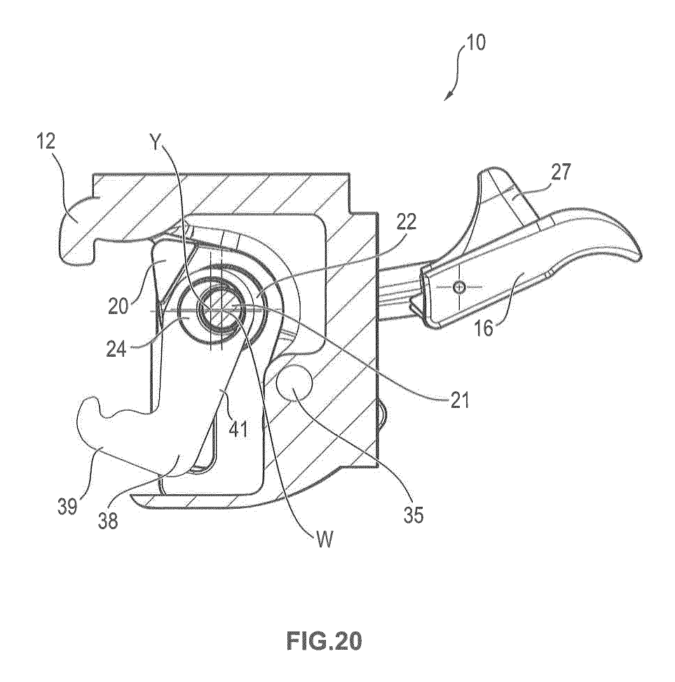

FIGS. 10 to 16 each show a side view of clamping claw 10 in a different phase during the positioning of clamping claw 10 on slide rail 100. In addition, FIGS. 17 to 21 each show a cross-section of clamping claw 10 from the perspective opposite that of FIGS. 10 to 16, each in a different phase during the detachment of clamping claw 10 from slide rail 100. In the phases shown in FIGS. 17, 18 and 19, the positions of the actuating lever are similar to those of the phases of positioning, shown in FIGS. 16, 15 and 14. In FIGS. 18 to 21, slide rail 100 is omitted.

In FIG. 10, swivel lock 38 is shown in a receiving position, prior to positioning on slide rail 100. Before being positioned on slide rail 100, swivel lock 38 may be prestressed by helical compression spring 54, not shown in FIG. 10 for clarity, such that the first arm 39 of swivel lock 38 is in a pivoted position inclined upward relative to horizontal. Further, when swivel lock 38 is in the receiving position, actuating lever 16 may be aligned substantially horizontally.

To position clamping claw 10 on slide rail 100, clamping claw 10 may be moved horizontally in the alignment shown in FIG. 10 up to slide rail 100 until swivel lock 38 contacts the outer rail surface 34. In so doing, swivel lock 38 may be pulled back, e.g. it may be pivoted about pivot axis Y opposite the prestressing force exerted by helical compression spring 54 (see FIG. 4) into main body 12, thereby freeing up space for receiving slide rail 100.

FIG. 11 shows a side view of clamping claw 10 with swivel lock 38 in an open position, after clamping claw 100 has been moved up to slide rail 100. Slide rail 100 may be contacted in a lower region 36 of outer rail surface 34 by main body 12, and may be contacted on the lower rail surface 32 by a region 45 of swivel lock 38. While swivel lock 38 is being pivoted into the open position shown in FIG. 11, actuating lever 16 may maintain its substantially horizontal alignment, because the pivoting movement of swivel lock 38 is not transferred to actuating lever 16. Specifically, with this pivoting movement, the elongated opening 64 formed in swivel lock 38 and the pin 40 formed on cam 24 and arranged in the swivel lock, as shown in FIG. 4, may be moved relative to one another without pin 40 coming into contact with one of stops 66, 68 of elongated opening 64. In this state, eccentric shaft 18, which may be fixedly connected to actuating lever 16, may remain unaffected by the pivoting movement of swivel lock 38.

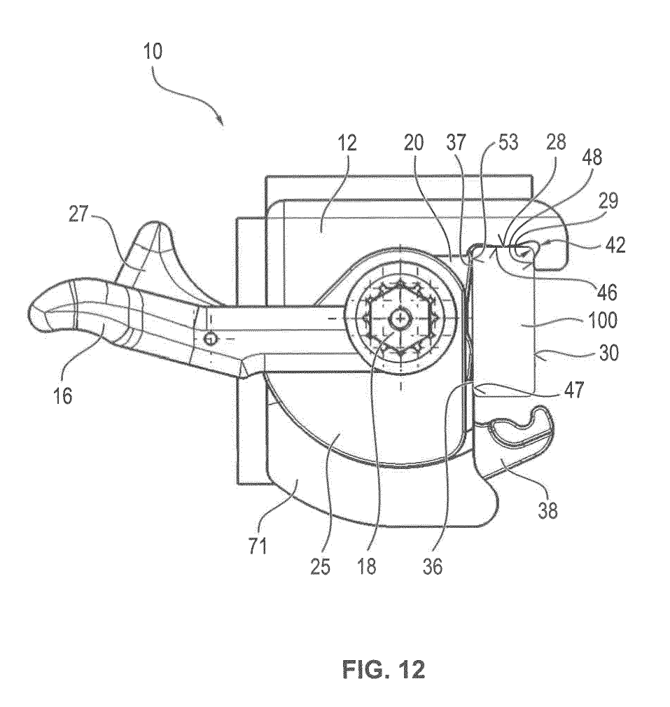

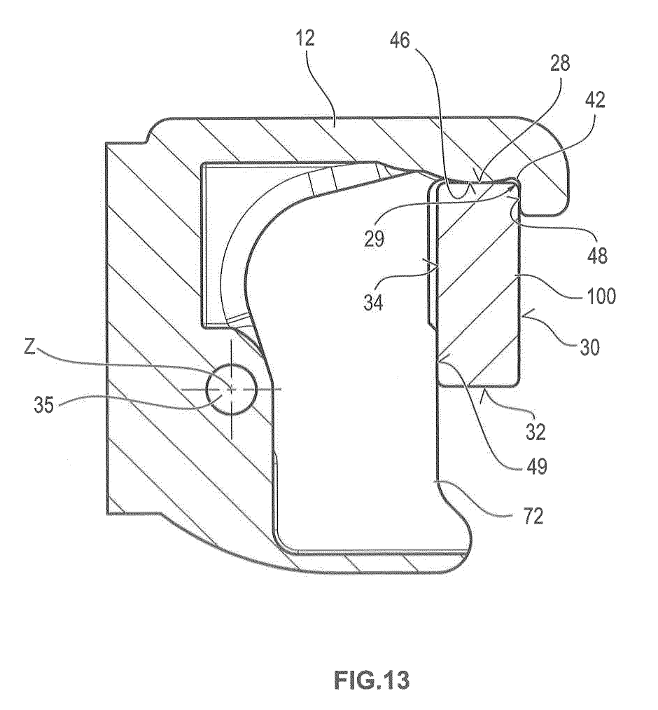

In the side view shown in FIG. 12, clamping claw 10 may be moved vertically downward relative to its position in FIG. 11, so that a convex first bearing surface 46 of main body 12 bears against the upper rail surface 28 and a second bearing surface 48 of main body 12 bears against the inner rail surface 30. The first rail edge 29, located between the upper rail surface 28 and the inner rail surface 30, may be received without contact in an edge recess 42 of main body 12. A third bearing surface 47 of a front side wall 71 of main body 12, as shown in FIG. 12, may bear against the lower region 36 of outer rail surface 34. In addition, a bearing surface 53 of support element 20 that is arranged in a region of support element 20 that faces away from pivot axis Z may bear against the upper region 37 of the outer rail surface 34 (see FIG. 4).

In the sectional side view of FIG. 13 showing main body 12 of clamping claw 10 bearing against slide rail 100, the bearing surfaces of main body 12 on slide rail 100 are illustrated. In addition to the bearing surfaces 46, 48 and bearing surface 47 of the front side wall 71, shown in FIG. 12, main body 12 may have a fourth bearing surface 49, which may be formed on a rear side wall 72, which is visible in FIG. 13 and which may bear against the lower region 36 of the outer rail surface 34.

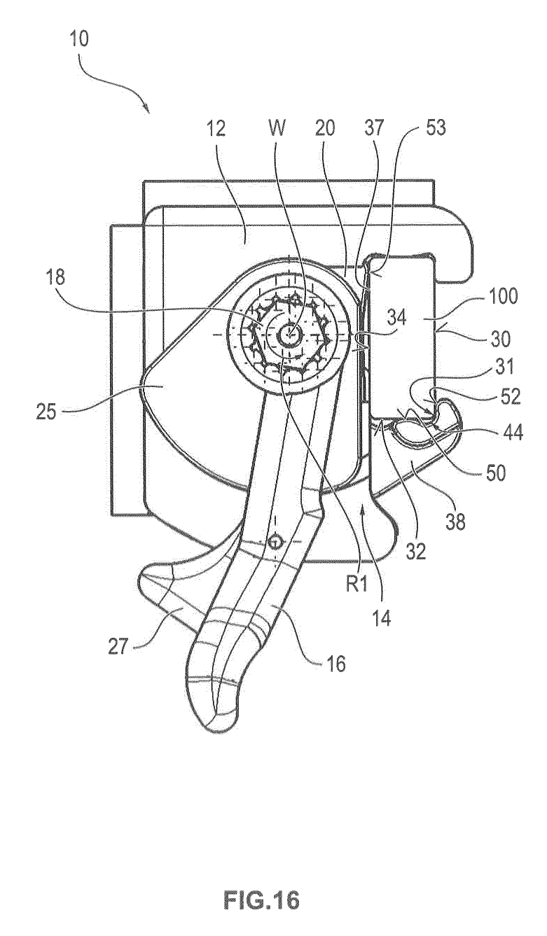

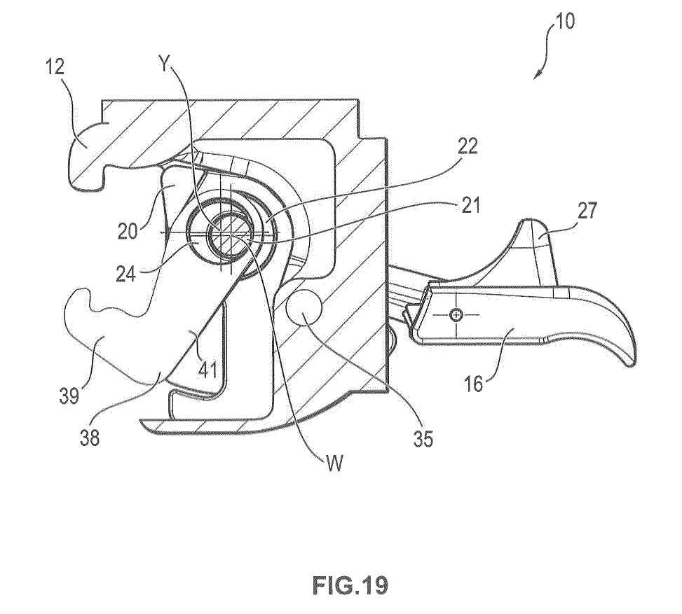

Starting from the state shown in FIGS. 12 and 13, actuating lever 16 is pivoted downward. With this pivoting movement of actuating lever 16, cam 24 may be pivoted about rotational axis W of eccentric shaft 18 in the first direction of rotation R1. The resulting state is shown in FIGS. 14 and 19. By pivoting cam 24 in the first direction of rotation R1 in FIG. 14, swivel lock 38 may be moved substantially upward, thereby moving a convex bearing surface 50 of swivel lock 38 toward lower rail surface 32. In the resulting state, swivel lock 38 may be in an intermediate position between the receiving position and a closed position, which is shown in FIG. 16 and will be described later. In addition, when actuating lever 16 is in this position, pawls 80 and 82 are engaged with the teeth of ratchet element 25.

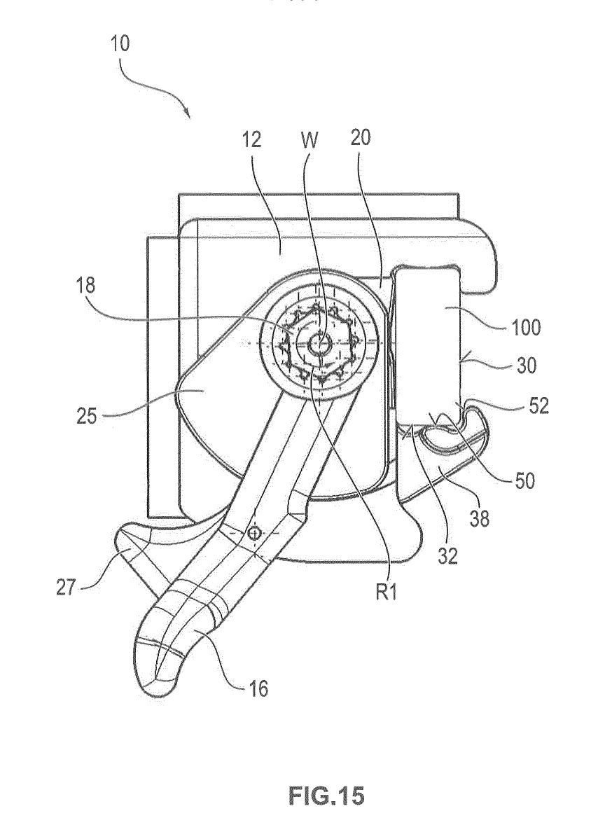

FIG. 15 shows a side view of clamping claw 10 positioned on slide rail 100 in a fixed state. Actuating lever 16 has been pivoted further about rotational axis W in the first direction of rotation R1, relative to its position in FIG. 14, until cam 24 is pivoted far enough about rotational axis W of eccentric shaft 18 that first bearing surface 50 of swivel lock 38 may bear against lower rail surface 32. In this state, a second bearing surface 52 of swivel lock 38, which may also be convex, may be located at a distance opposite inner rail surface 30 and may thereby secure clamping claw 10, substantially preventing it from becoming detached from slide rail 100.

In addition, pawls 80 and 82 may be engaged with saw teeth 78 and may lock actuating lever 16 in place, substantially preventing it from rotating in the second direction of rotation R2. In this way, swivel lock 38 may be prevented from moving backward, thereby substantially preventing clamping claw 10 from opening.

FIG. 16 shows a side view of clamping claw 10 positioned on slide rail 100, with clamp structure 14 in the locked state. In this state, cam 24 has been pivoted further about rotational axis W in the first direction of rotation R1, relative to the position shown in FIG. 15, by a further pivoting of actuating lever 16, such that the first arm 39 of swivel lock 38 may be moved far enough toward slide rail 100 that bearing surface 52 of swivel lock 38 bears against inner rail surface 30. A second rail edge 31, located between inner rail surface 30 and lower rail surface 32, may be received without contact in an edge recess 44 of swivel lock 38. Swivel lock 38 may thus be in the closed position.

In addition, when swivel lock 38 is in the closed position, first pawl 80 and second pawl 82 may be engaged with saw teeth 78, whereby clamp structure 14 may be in the locked state, in which actuating lever 16 is locked in place and clamping claw 10 is securely mounted on slide rail 100. Clamping claw 10 may be suitable for attachment to slide rails of different dimensions. Thus, in addition to swivel lock 38, support element 20 can also be pivoted toward slide rail 100 until its contact surface 53 bears against the upper region 37 of slide rail 100. If the rail dimensions involve pivoting of support element 20, the support element may be pivoted up to the outer rail surface 34 after the first contact surface 50 of swivel lock 38 has been pivoted up to the lower rail surface 32. For this purpose, eccentric shaft 18 may be moved downward by a continued pivoting of actuating lever 16 in the first direction of rotation R1, while contact surface 50 of swivel lock 38 bears against the lower rail surface 32 in FIG. 2, and as a result, support element 20 may be pivoted about pivot axis Z in the direction of slide rail 100. During the securing of clamping claw 10 on a correspondingly configured slide rail, the closed position of swivel lock 38 may be a position other than what is shown in FIG. 16. For example, in the position shown in FIG. 18, swivel lock 38 may be in the closed position and clamp structure 14 may be in the locked state.

Clamping claw 10 may be detached from slide rail 100 by performing the steps described above in substantially reverse order. Starting from the state shown in FIG. 17, actuating element 27 may be pressed down in order to disengage pawl and ratchet mechanism 26. While actuating element 27 is pressed down, actuating lever 16 may then be pivoted about its rotational axis W until it reaches the horizontal position shown in FIG. 12. During this pivoting operation, actuating lever 16 may pass through the positions shown in FIGS. 18 and 19. During the pivoting operation, cam 24 may be pivoted about rotational axis W of eccentric shaft 18 in the second direction of rotation R2, thereby moving the first arm 39 of swivel lock 38 away from slide rail 100.

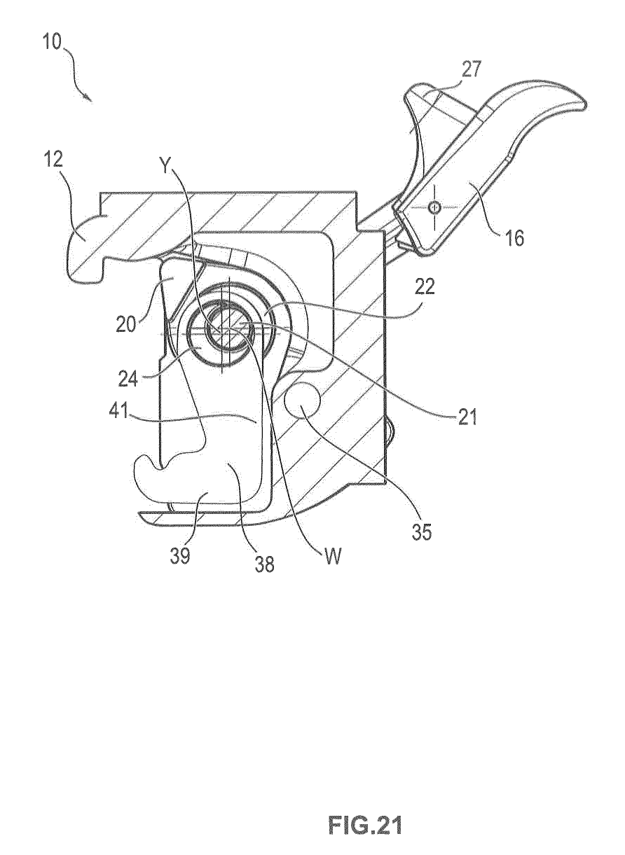

As actuating lever 16 is pivoted further in the second direction of rotation R2, cam 24 may be pivoted further about rotational axis W of eccentric shaft 18 in the second direction of rotation R2, and swivel lock 38 may be moved along with it. During this operation, helical compression spring 54 may act against the rotation of swivel lock 38 induced by the co-movement, thereby rotating cam 24 about its longitudinal axis Y relative to swivel lock 38. This may cause the pin 40, shown in FIG. 4, to rotate along elongated opening 64 in the second direction of rotation until pin 40 strikes the second stop 68 of swivel lock 38. As the rotation of actuating lever 16 in the second direction of rotation R2 continues, swivel lock 38 may be pivoted, by the contact with pin 40, together with cam 24 about the longitudinal axis Y thereof in the second direction of rotation R2 until swivel lock 38 is in the open position shown in FIG. 21. In this position, actuating lever 16 may be pivoted upward relative to the horizontal position shown in FIG. 10.

In the position that is reached in FIG. 21, clamping claw 10 can be moved vertically upward until the hook-shaped main body 12 is in the position shown in FIG. 11 and the clamping claw 10 can be removed from slide rail 100 in the horizontal direction shown in FIG. 11. Once clamping claw 10 has been removed, actuating lever 16 can be pivoted back into the relaxed position, which is horizontal in FIG. 11, in which swivel lock 38 is back in the receiving position shown in FIG. 10, and swivel lock 38 is prestressed by helical compression spring 54.

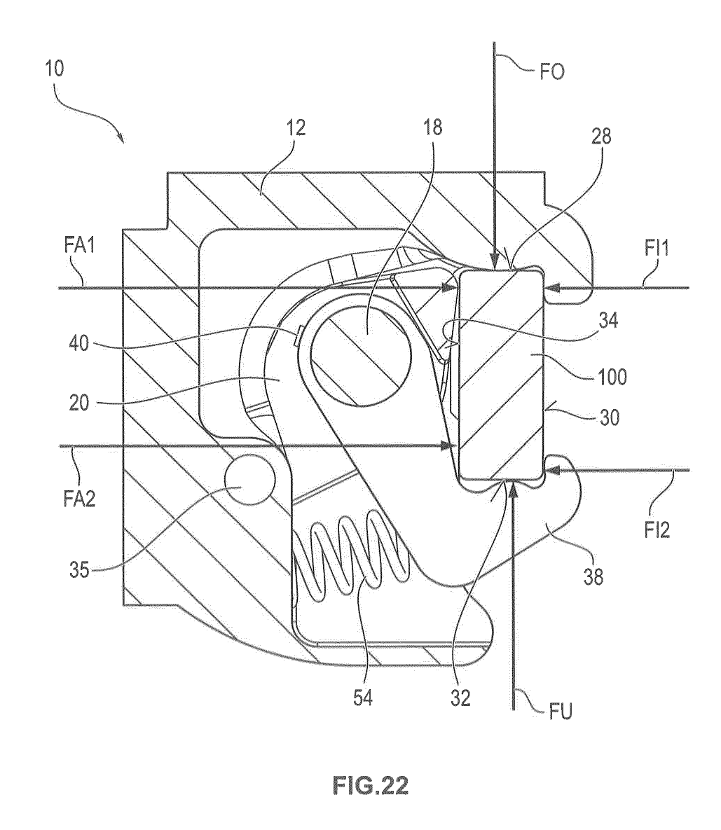

In the sectional side view of FIG. 22, showing clamping claw 10 bearing against slide rail 100, the forces acting on slide rail 100 when clamp structure 14 is in the locked state are indicated. Here, main body 12 may act on the upper rail surface 28 of slide rail 100 with a force FO, on its inner rail surface 30 with a force FI1 and on its outer rail surface 34 with a force FA2. In addition, support element 20 may act on outer rail surface 34 with a force FA1 and swivel lock 38 may act on lower rail surface 32 with a force FU and on the inner rail surface 30 with a force FI2. By pivoting actuating lever 16, the forces acting on slide rail 100 can be adjusted such that they are great enough to securely fix clamping claw 10 on slide rail 100 by virtue of the frictional forces acting between clamping claw 10 and slide rail 100.

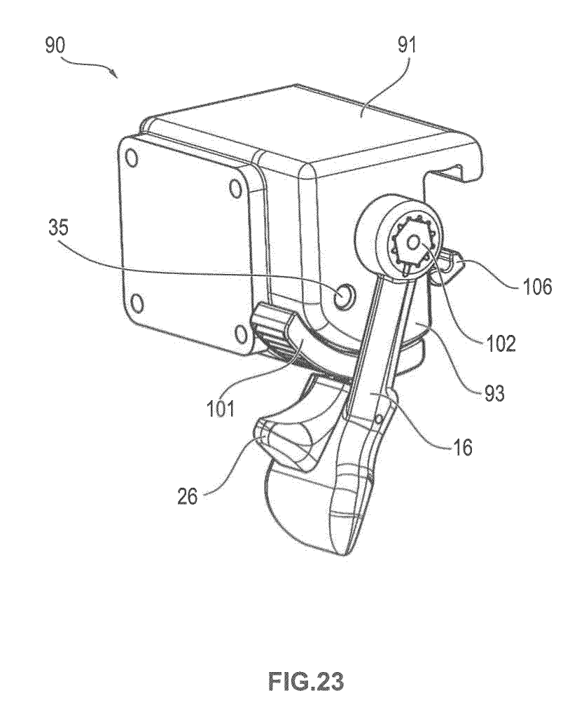

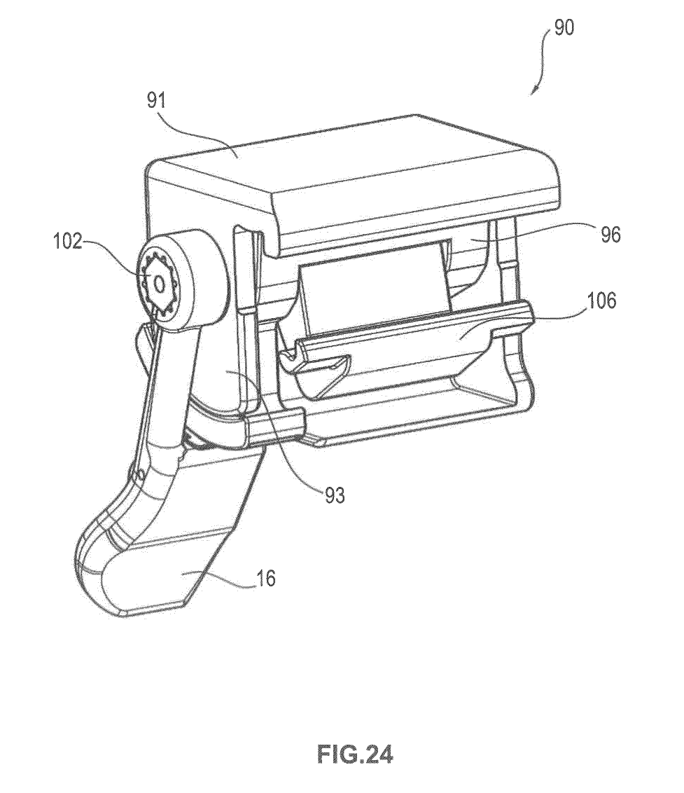

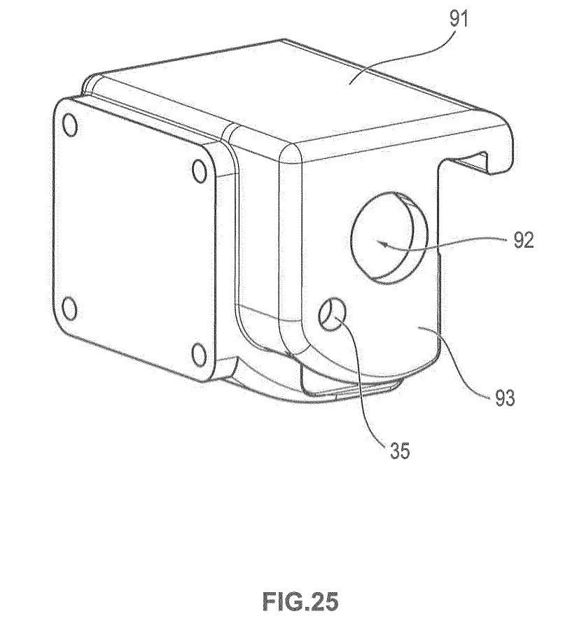

FIGS. 23 and 24 each show a perspective view of a clamping claw 90 according to a second embodiment. Clamping claw 90 may have a main body 91, which may be different from the main body 90 of the first exemplary embodiment. In contrast to the first exemplary embodiment shown in FIG. 3, the main body 91 shown separately in FIG. 25 may have a borehole 92 on the side wall 93 that faces actuating lever 16, in place of the recess 94 that is provided in the first exemplary embodiment. In addition, side wall 93 of main body 91 may have a larger recess on its side that is the lower side in FIG. 3 than the side wall 95 of the first embodiment, and the upper coupling interface 13b may be dispensed with.

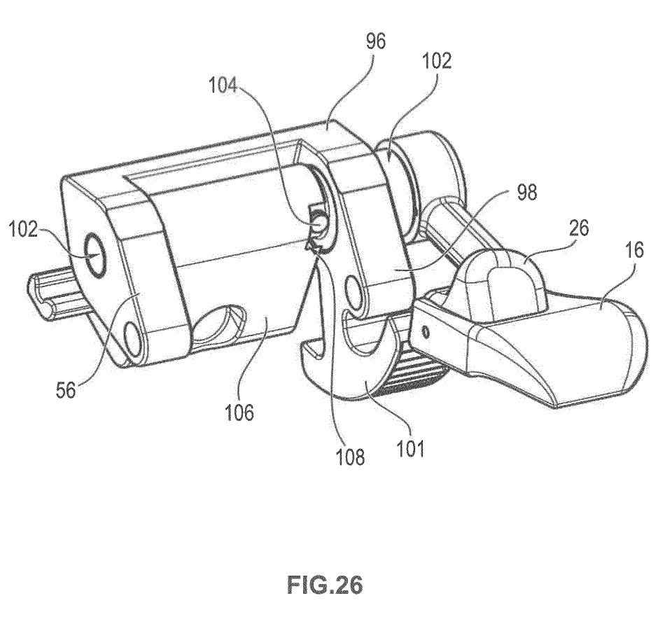

The second embodiment further may have a support element 96, the second arm 98 of which is designed as a ratchet element 101 on its lower side, as shown in FIG. 26. In FIG. 23, ratchet element 101 of support element 96 may be located below side wall 93 of main body 91.

A further difference from the first embodiment is that, in place of eccentric shaft 18, an eccentric shaft 102 may be provided, which has a pin 104 that is offset relative to that of the first exemplary embodiment. Pin 104 may be located directly adjacent to the second arm 98 and may be rotated 90° about longitudinal axis Y of cam 24 relative to pin 40 of the first exemplary embodiment.

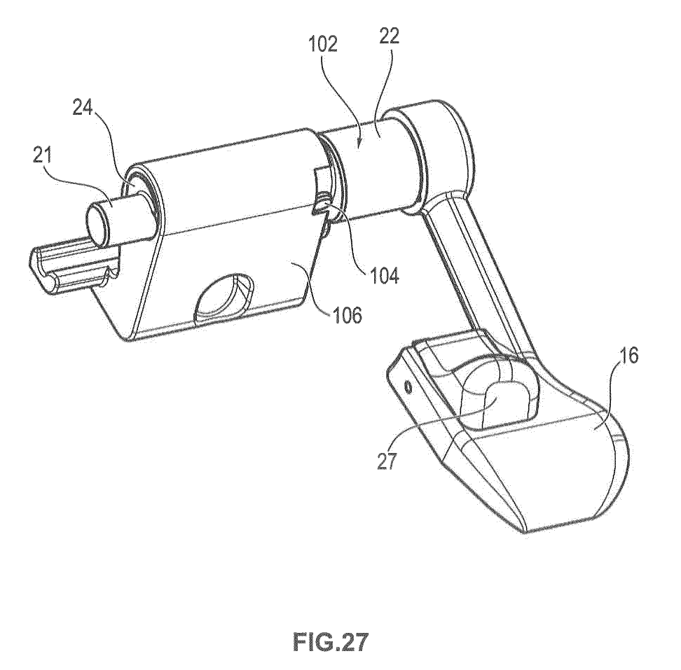

In addition, in place of swivel lock 38, a swivel lock 106 may be provided, the elongated opening of which may be offset in accordance with the positioning of pin 104, and which has a recess 108 in place of the first stop 66. Eccentric shaft 102 may have no third shaft section, as is indicated in FIG. 27.

In at least some exemplary embodiments, the disclosed apparatus may be relatively easy to assemble and economical to produce.

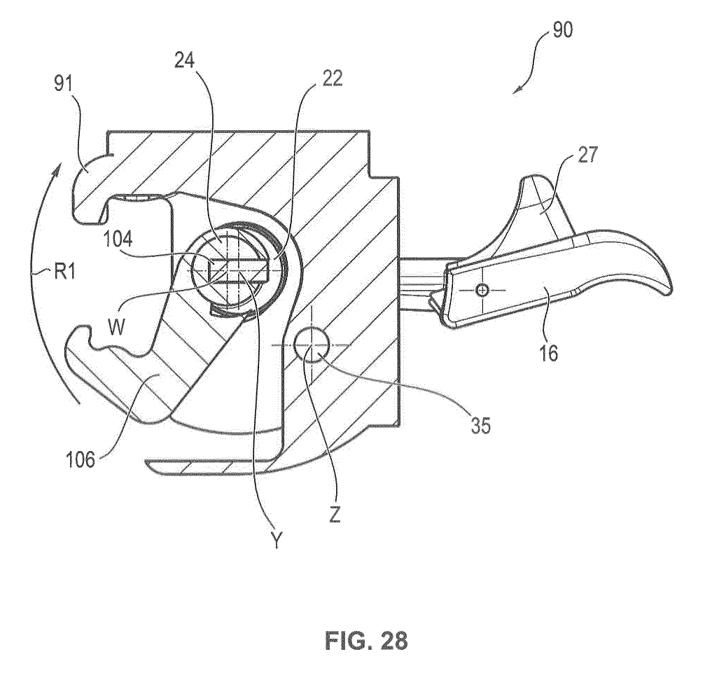

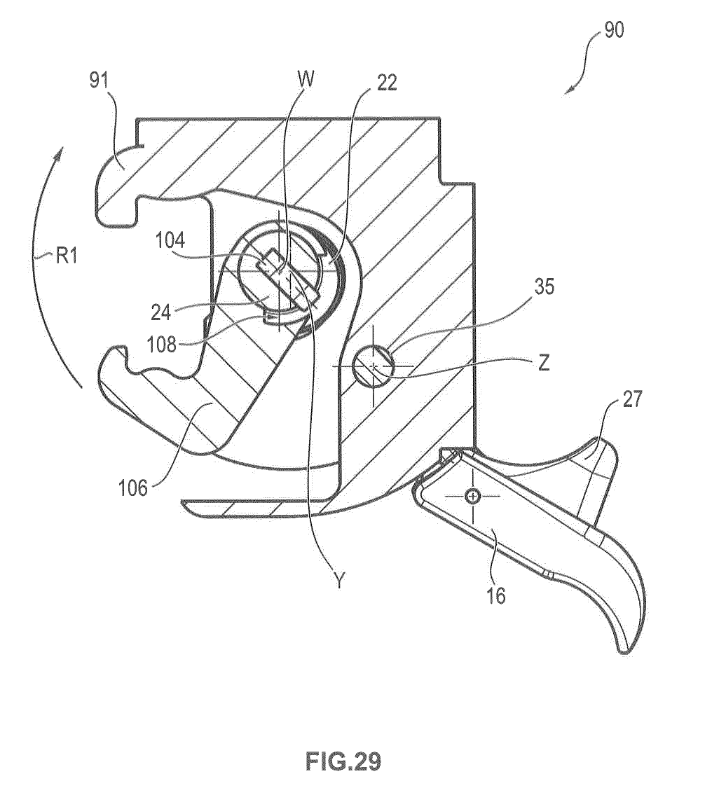

The different design of swivel lock 106 will be described in the following with reference to FIGS. 28 to 31, in which clamping claw 90 is shown in various positions, each showing a cross-section through pin 104 with support element 96 omitted.

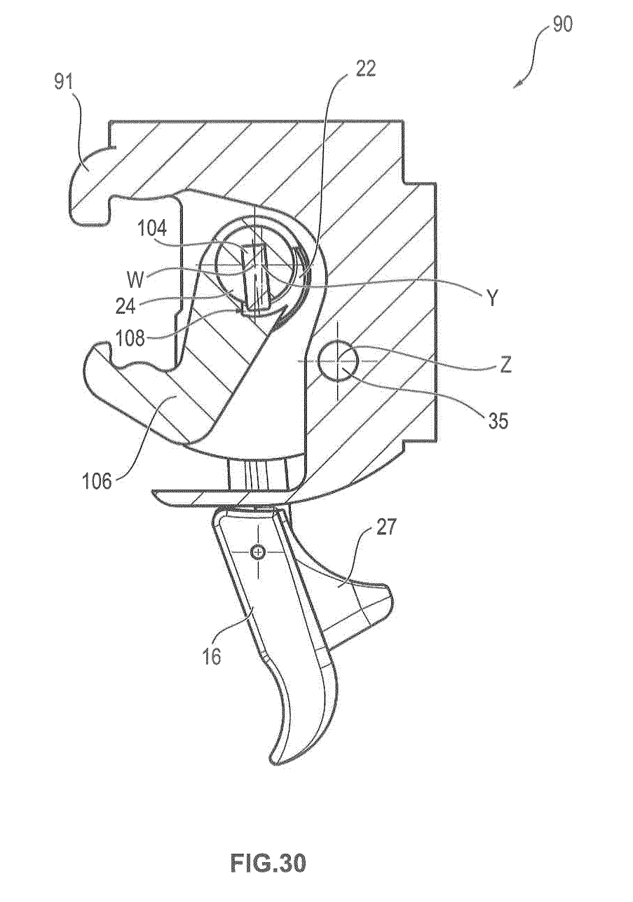

Starting from the receiving position shown in FIG. 28, a pivoting movement of actuating lever 16 may cause pin 104 to pivot relative to swivel lock 106 about longitudinal axis Y of cam 24 in the first direction of rotation R1, into the position shown in FIG. 29. Pawls 80 and 82 of actuating lever 16 may thereby be engaged with the first tooth of the teeth of ratchet element 101. This position of actuating lever 16 may correspond to the closed position of swivel lock 106, and to a locked clamp structure 14 when clamping claw 90 is secured to a particularly large slide rail.

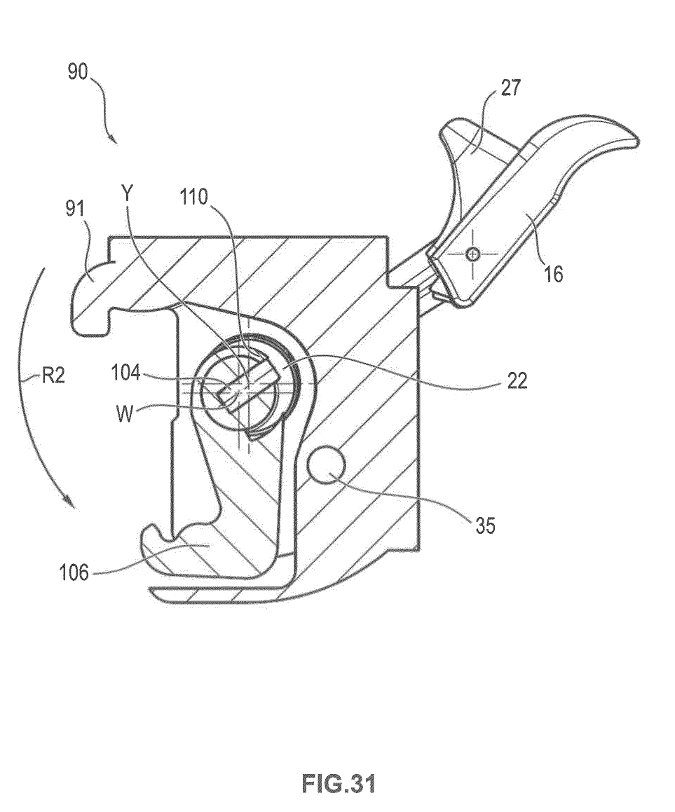

As the pivoting movement is continued into the position shown in FIG. 30, pin 104 may be pivoted into recess 108 of swivel lock 106. In FIG. 30, swivel lock 106 is shown in the closed position that results from such an exemplary pivoting movement. Swivel lock 106 may be fixed on slide rail 100 by the positioning of cam 24 in the position shown in FIG. 30. Pin 104 may not be in contact with swivel lock 106, but may substantially prevent clamping claw 90 from becoming detached from slide rail 100 when clamping claw 90 is pressed against slide rail 100.

However, in the open position, with the corresponding pivoting of actuating lever 16 about rotational axis W in the second direction of rotation R2, pin 104 may be in contact with swivel lock 106 at a stop 110, which may correspond to second stop 68 of the first embodiment of clamping claw 10, as shown in FIG. 31.

It will be apparent to those skilled in the art that various modifications and variations can be made to the disclosed method and apparatus. Other embodiments will be apparent to those skilled in the art from consideration of the specification and practice of the disclosed method and apparatus. It is intended that the specification and the disclosed examples be considered as exemplary only, with a true scope being indicated by the following claims.

What is claimed is:

1. A clamping apparatus that is attachable to a structural member of an operating table, comprising:
a main body having at least one bearing surface designed to bear against the structural member of the operating table;
a clamp assembly that is attached to the main body and has a first bearing member and a second bearing member; and
an actuating assembly that is operatively connected to the clamp assembly and that actuates the clamp assembly into a locked state in which the at least one bearing surface of the main body and the first and second bearing members of the clamp assembly bear against the structural member;
wherein the first bearing member is mounted pivotably about a first pivot axis, the first pivot axis being parallel to a longitudinal axis of the structural member and the first pivot axis being stationary relative to the main body;
wherein the second bearing member is mounted pivotably about a second pivot axis, the second pivot axis being parallel to the first pivot axis and the second pivot axis being movable relative to the main body;
wherein the actuating assembly is operatively connected to the second bearing member; and
wherein upon actuation of the actuating assembly, the first bearing member is pivoted about the first pivot axis so as to bear against the structural member.

2. The clamping apparatus according to claim 1, wherein:
the clamp assembly includes an eccentric shaft, which is coupled to the actuating assembly and which is pivotable together with the first bearing member about the first pivot axis;
the eccentric shaft includes at least one shaft section, which is rotatable about a rotational axis of the eccentric shaft, and a cam, which is eccentric in relation to the rotational axis of the eccentric shaft;
the second pivot axis is stationary relative to the cam; and
the second bearing member is mounted pivotably on the cam.

3. The clamping apparatus according to claim 2, wherein:
the shaft section of the eccentric shaft is mounted on the first bearing member so as to rotate about the rotational axis of the eccentric shaft;
the eccentric shaft is rotatable about its rotational axis by actuating the actuating assembly; and
when the eccentric shaft is rotated about its rotational axis, the cam is pivoted.

4. The clamping apparatus according to claim 2, wherein:
the second bearing member includes a through hole through which the cam is guided, the at least one shaft section including a first shaft section and a second shaft section; and
the cam is located between the first shaft section and the second shaft section.

5. The clamping apparatus according to claim 4, wherein:
the first shaft section, the second shaft section, and the cam are each cylindrical;
the first shaft section and the second shaft section have a common longitudinal axis that forms the rotational axis of the eccentric shaft; and
the cam is disposed relative to the first and second shaft sections such that the longitudinal axis of the cam is disposed at a distance from and parallel to the longitudinal axis of the first and second shaft sections.

6. The clamping apparatus according to claim 4, wherein:
the first bearing member includes a first arm and a second arm;
the second bearing member is disposed between the first arm and the second arm of the first bearing member;
the first arm has a first opening and the second arm has a second opening; and
the first shaft section is guided through the first opening and the second shaft section is guided through the second opening.

7. The clamping apparatus according to claim 2, wherein:
a pin is connected to the cam and protrudes into a recess in the second bearing member;
upon rotation of the eccentric shaft about its rotational axis, the pin is brought into engagement with the second bearing member; and
as the rotation of the eccentric shaft about its rotational axis continues, and with the pin in engagement, the second bearing member is pivoted about the second pivot axis.

8. The clamping apparatus according to claim 1, wherein:
the clamp assembly includes a prestressing member, by which the second bearing member is prestressed into a receiving position; and
when the main body bears against the structural member, the bearing surface of the second bearing member is pressed by the prestressing member against the structural member.

9. The clamping apparatus according to claim 2, wherein:
the actuating assembly is an actuating lever that is fixedly connected to the eccentric shaft and is pivotable with the eccentric shaft about the rotational axis of the eccentric shaft; and
the clamping apparatus includes a pawl and ratchet mechanism, by which the actuating lever is locked in place when the clamp assembly is in the locked state.

10. The clamping apparatus according to claim 9, wherein:
the pawl and ratchet mechanism includes a ratchet element that is connected to the first bearing member and at least one pawl that is connected to the actuating lever; and
when the pawl is in interlocking engagement with the ratchet element, the actuating lever is locked in place.

11. A clamping apparatus that is attachable to a structural member of an operating table, comprising:
a main body having at least one bearing surface designed to bear against the structural member of the operating table;
a clamp assembly that is attached to the main body and has a first bearing member and a second bearing member; and
an actuating assembly that is operatively connected to the clamp assembly and that actuates the clamp assembly into a locked state in which the at least one bearing surface of the main body and the first and second bearing members of the clamp assembly bear against the structural member;
wherein the first bearing member is mounted pivotably about a first pivot axis, the first pivot axis being parallel to a longitudinal axis of the structural member and the first pivot axis being stationary relative to the main body;
wherein the second bearing member is mounted pivotably about a second pivot axis, the second pivot axis being parallel to the first pivot axis and the second pivot axis being movable relative to the main body;
wherein the actuating assembly is operatively connected to the second bearing member;
wherein upon actuation of the actuating assembly, the first bearing member is pivoted about the first pivot axis so as to bear against the structural member;
wherein when the clamp assembly is in the locked state, the bearing surface of the main body bears against a first side of the structural member; and
wherein when the clamp assembly is in the locked state, a bearing surface of the first bearing member bears against a second side of the structural member.

12. The clamping apparatus according to claim 11, wherein when the clamp assembly is in the locked state, a bearing surface of the second bearing member bears against a third side of the structural member.

13. The clamping apparatus according to claim 12, wherein when the clamp assembly is in the locked state, an additional bearing surface of the main body bears against a fourth side of the structural member.

14. The clamping apparatus according to claim 13, wherein when the clamp assembly is in the locked state, an additional bearing surface of the second bearing member bears against the fourth side of the structural member.

15. The clamping apparatus according to claim 14, wherein:
the main body includes an edge recess, located between the bearing surface of the main body and the additional bearing surface of the main body; and
the edge recess receives a first rail edge, which is situated between the first side of the structural member and the fourth side of the structural member, without contact.

16. The clamping apparatus according to claim 15, wherein:
the second bearing member bears against an edge region of the structural member; and
the second bearing member includes a second bearing member edge recess that receives a second rail edge without contact, the second rail edge being disposed between the third and fourth sides of the structural member.

17. A clamping apparatus that is attachable to a slide rail of an operating table, comprising:
a main body having at least one bearing surface designed to bear against the slide rail of the operating table;
a clamp assembly that is attached to the main body and has a first bearing member and a second bearing member; and
an actuating assembly that is operatively connected to the clamp assembly and that actuates the clamp assembly into a locked state in which the at least one bearing surface of the main body and the first and second bearing members of the clamp assembly bear against the slide rail;
wherein the first bearing member is mounted pivotably about a first pivot axis, the first pivot axis being parallel to a longitudinal axis of the slide rail and the first pivot axis being stationary relative to the main body;
wherein the second bearing member is mounted pivotably about a second pivot axis, the second pivot axis being parallel to the first pivot axis and the second pivot axis being movable relative to the main body;
wherein the actuating assembly is operatively connected to the second bearing member;
wherein upon actuation of the actuating assembly, the first bearing member is pivoted about the first pivot axis so as to bear against the slide rail; and
wherein the clamp assembly includes an eccentric shaft, which is coupled to the actuating assembly and which is pivotable together with the first bearing member about the first pivot axis.

18. The clamping apparatus according to claim 17, wherein the eccentric shaft includes at least one shaft section, which is rotatable about a rotational axis of the eccentric shaft, and a cam, which is eccentric in relation to the rotational axis of the eccentric shaft.

19. The clamping apparatus according to claim 18, wherein:
the second pivot axis is stationary relative to the cam; and
the second bearing member is mounted pivotably on the cam.

20. The clamping apparatus according to claim 18, wherein:
the shaft section of the eccentric shaft is mounted on the first bearing member so as to rotate about the rotational axis of the eccentric shaft;
the eccentric shaft is rotatable about its rotational axis by actuating the actuating assembly; and
when the eccentric shaft is rotated about its rotational axis, the cam is pivoted.
